(19) United States
(12) Patent Application Publication
(10) Pub. No.: US 2026/0252575 A1
(43) Pub. Date: Aug. 27, 2026

(54) METHOD FOR DETERMINING AN EFFECT VIDEO, ELECTRONIC DEVICE AND STORAGE MEDIUM

(71) Applicant: Beijing Zitiao Network Technology Co., Ltd., Beijing (CN)

(72) Inventors: Mengna TONG, Beijing (CN); Lin YAN, Beijing (CN); Chao QIAO, Beijing (CN); Shenjian ZHAO, Beijing (CN); Cheng LV, Beijing (CN); Aonan TAN, Beijing (CN)

(21) Appl. No.: 18/730,481

(22) PCT Filed: Mar. 12, 2024
(86) PCT No.: PCT/CN2024/081062

§ 371 Date: Jul. 19, 2024

(30) Foreign Application Priority Data
Apr. 10, 2023 (CN) 202310376230.7

(51) Int. Cl. G06F 16/248

(52) U.S. Cl. CPC G06F 16/248

(57) ABSTRACT

The present disclosure provides a search result display method and apparatus, a computer device, and a storage medium. The method includes: receiving search information; acquiring an artificial intelligence answer result corresponding to the search information, in response to a search type corresponding to the search information belonging to a target search type, the target search type including a creation type and a target search type indicating that search results corresponding to the search information fail to satisfy a search demand, the target search type including: a first type that a satisfaction degree of a corresponding first-rank search result to the search demand does not meet a first requirement, or a second type that a satisfaction degree of any corresponding search result to the search demand does not meet a second requirement; and displaying the artificial intelligence answer result in a preset display position on a search result page.

The present application claims priority of Chinese Patent Application No. 202310376230.7 filed on Apr. 10, 2023, the disclosure of which is incorporated herein by reference in its entirety as part of the present application.

### TECHNICAL FIELD

Embodiments of the present disclosure relate to a search result display method and apparatus, a computer device, and a storage medium.

### BACKGROUND

With the development of Internet technology, obtaining information through the Internet has become one of the main ways for people to obtain information. A user may input question information into a search engine to obtain search results corresponding to the question information.

When the user inputs question information, for example, writing, life emotions, and other questions with strong personalized demands, it is usually difficult to obtain a good answer, or the user has to read the contents of a plurality of search results to obtain a complete answer. Therefore, how to improve the quality of searched answers is an urgent problem to be solved.

### SUMMARY

The embodiment of the disclosure at least provides a search result display method and apparatus, a computer device, and a storage medium.

In a first aspect, embodiments of the present disclosure provide a search result display method, including:
receiving search information;
acquiring an artificial intelligence answer result corresponding to the search information, in response to a search type corresponding to the search information belonging to a target search type, wherein the target search type comprises a creation type and a target search type indicating that search results corresponding to the search information fail to satisfy a search demand, the target search type includes: a first type that a satisfaction degree of a corresponding first-rank search result to the search demand does not meet a first requirement, or a second type that a satisfaction degree of any corresponding search result to the search demand does not meet a second requirement, wherein the first requirement is higher than the second requirement; and
displaying the artificial intelligence answer result in a preset display position on a search result page.

In combination with the first aspect, the embodiment of the present disclosure provides a first possible implementation of the first aspect, wherein the search type corresponding to the search information belongs to the creation type, and the artificial intelligence answer result corresponding to the search information comprises a plurality of answer results;
the displaying the artificial intelligence answer result in a preset display position on a search result page, includes:
displaying one of the plurality of answer results in the preset display position, and displaying a next answer result among the plurality of answer results in response to an answer result switch operation.

In combination with the first possible implementation of the first aspect, the embodiment of the present disclosure provides a second possible implementation of the first aspect, wherein the displaying one of the plurality of answer results in the preset display position, and displaying a next answer result among the plurality of answer results in response to an answer result switch operation, includes:
displaying an artificial intelligence card in the preset display position, wherein one of the plurality of answer results is displayed in the artificial intelligence card; and switching the answer result in the artificial intelligence card to the next answer result among the plurality of answer results in response to the answer result switch operation; or,
displaying a first artificial intelligence card in the preset display position, wherein one of the plurality of answer results is displayed in the first artificial intelligence card; switching the first artificial intelligence card to a next artificial intelligence card in response to the answer result switch operation, wherein the next answer result among the plurality of answer results is displayed in the next artificial intelligence card.

In combination with the first aspect, the embodiment of the present disclosure provides a third possible implementation of the first aspect, wherein the search type corresponding to the search information belongs to the first type;
the displaying the artificial intelligence answer result in a preset display position on a search result page, includes:
displaying the artificial intelligence answer result above respective search results on the search result page.

In combination with the first aspect, the embodiment of the present disclosure provides a fourth possible implementation of the first aspect, wherein the search type corresponding to the search information belongs to the second type;
the displaying the artificial intelligence answer result in a preset display position on a search result page, includes:
displaying a structured artificial intelligence answer result in the preset display position on the search result page, wherein the structured artificial intelligence answer result comprises a plurality of structured answers and comparison information between the plurality of structured answers, and each structured answer comprises information under a plurality of content dimensions.

In combination with the first aspect, the embodiment of the present disclosure provides a fifth possible implementation of the first aspect, wherein the displaying the artificial intelligence answer result in a preset display position on a search result page, comprises:
displaying a target consumption window in the preset display position, and displaying at least part of content of the answer result within the target consumption window;
updating and displaying the answer result within the target consumption window in response to a slide operation for the target consumption window.

In combination with the first aspect, the embodiment of the present disclosure provides a sixth possible implementation of the first aspect, wherein, before the acquiring an artificial intelligence answer result corresponding to the search information, the method further includes:
displaying respective search results corresponding to the search information and prompt information on the search result page, wherein the prompt information is used to prompt that the artificial intelligence answer result is being generated;
the displaying the artificial intelligence answer result in a preset display position on a search result page, includes:
canceling a display of the prompt information and displaying the answer result in the preset display position.

In combination with the first aspect, the embodiment of the present disclosure provides a seventh possible implementation of the first aspect, wherein, after the displaying the artificial intelligence answer result in a preset display position on a search result page, the method further comprises:
in response to a trigger operation for the artificial intelligence answer result, displaying an artificial intelligence search page, displaying entire content of the artificial intelligence answer result and instruction information for instructing to input question information on the artificial intelligence search page, to update the artificial intelligence answer result according to the question information.

In a second aspect, the embodiment of the present disclosure also provides a search result display apparatus, including:
a receiving module, configured to receive search information;
an acquiring module, configured to acquire an artificial intelligence answer result corresponding to the search information in response to a search type corresponding to the search information belonging to a target search type, wherein the target search type comprises a creation type and a target search type indicating that search results corresponding to the search information fail to satisfy a search demand, the target search type comprises: a first type that a satisfaction degree of a corresponding first-rank search result to the search demand does not meet a first requirement, or a second type that a satisfaction degree of any corresponding search result to the search demand does not meet a second requirement, wherein the first requirement is higher than the second requirement; and
a first display module, configured to display the artificial intelligence answer result in a preset display position on a search result page.

In a third aspect, the embodiment of the present disclosure also provides a computer device, including: a processor, a memory, and a bus, wherein the memory stores machine-readable instructions executable by the processor, when the computer device is running, the processor communicates with the memory through the bus; and the machine-readable instructions, when executed by the processor, execute the embodiments in the first aspect described above, or in any alternative embodiment of the first aspect.

In a fourth aspect, the embodiment of the present disclosure also provides a computer-readable storage medium, having a computer program stored thereon, wherein the computer program, when run by a processor, executes the embodiments in the first aspect described above, or in any alternative embodiment of the first aspect.

In order to make the above-described objectives, features, and advantages of the present disclosure more obvious and understandable, preferred embodiments are provided below, and illustrated in detail in conjunction with the accompanying drawings.

### BRIEF DESCRIPTION OF DRAWINGS

In order to explain the technical scheme of the embodiment of the present disclosure more clearly, the following will briefly introduce the drawings needed in the embodiment, which are incorporated into and constitute a part of this specification, and together with the specification, they show the embodiment in line with the present disclosure and serve to explain the technical scheme of the present disclosure. It should be understood that the following drawings only show some embodiments of the disclosure, so they should not be regarded as limiting the scope. For ordinary people in the field, other related drawings can be obtained according to these drawings without creative work.

FIG. 1 shows a flow chart of a search result display method provided by an embodiment of the present disclosure;

FIG. 2 shows a schematic diagram of a search result page provided by the embodiment of the present disclosure;

FIG. 3 shows a schematic diagram of another search result page provided by the embodiment of the present disclosure;

FIG. 4 shows a schematic diagram of still another search result page provided by the embodiment of the present disclosure;

FIG. 5 shows a schematic diagram of an artificial intelligence search page provided by the embodiment of the present disclosure;

FIG. 6 shows a schematic diagram of still another search result page provided by the embodiment of the present disclosure;

FIG. 7 shows a schematic diagram of still another artificial intelligence search page provided by the embodiment of the present disclosure;

FIG. 8 shows a structural schematic diagram of a search result display apparatus provided by an embodiment of the present disclosure; and

FIG. 9 shows a schematic diagram of a computer device provided by an embodiment of the present disclosure.

### DETAILED DESCRIPTION

To make the purpose, technical scheme, and advantages of the embodiment of the disclosure clearer, the technical scheme in the embodiment of the disclosure will be described clearly and completely in the attached drawings. The described embodiment is only a part of the embodiment of the disclosure, but not the whole embodiment. The components of the embodiments of the present disclosure generally described and illustrated in the drawings herein may be arranged and designed in various configurations. Therefore, the following detailed description of the embodiments of the disclosure provided in the accompanying drawings is not intended to limit the scope of the claimed disclosure but merely represents selected embodiments of the disclosure. Based on the embodiment of the present disclosure, all other embodiments obtained by those skilled in the art without creative work belong to the scope of protection of the present disclosure.

In the process of acquiring search results by inputting question information, when a user inputs questions with strong personalized demands such as writing, life emotions, etc., it is usually difficult to obtain a good answer, or the user has to read the content of a plurality of search results to obtain a complete answer. Therefore, how to improve the quality of searched answers is an urgent problem to be solved.

Based on this, the present disclosure provides a search result display method, including: receiving search information; acquiring an artificial intelligence answer result corresponding to the search information in response to a search type corresponding to the search information belonging to a target search type, the target search type including a creation type, and a target search type that a search result corresponding to the search information fails to satisfy a search demand, the target search type including: a first type that a satisfaction degree of a corresponding first-rank search result to the search demand does not meet a first requirement or a second type that a degree satisfaction of any search result to the search demand does not meet a second requirement, the first requirement being higher than the second requirement; and displaying the artificial intelligence answer result in a preset display position on a search result page.

In the embodiment of the present disclosure, the artificial intelligence answer result is an answer result generated for search information by using AI technology, that is, through a trained network model. When the first-rank search result corresponding to the search information fails to satisfy the search demand well, or none of the search results satisfies the search demand, the AI answer result may better satisfy the search demand of a user as compared with the search results provided by a search engine. For the search of a creation type, the network model may generate an answer with certain creative randomness and real-time property, so it may generate a strong personalized answer result, allowing different users to acquire different creation results for the same creation theme. In addition, as compared with a single search result provided by the search engine, the network model may also generate an integrated answer result that is more complete, that is, may better answer some questions that need integrating a plurality of answers to obtain a more complete answer, generate an answer result with better quality, and thus better satisfy the search demand of users.

The shortcomings of the above solutions and the proposed solutions are all the results of an inventor through practice and careful study. Therefore, the discovery process of the above-described problems and solutions proposed in the present disclosure with respect to the above-described problems in the following text should all be the contributions made by the inventor to the present disclosure process.

It should be noted that: similar reference signs and letters indicate similar items in the drawings below; and therefore, once a certain item is defined in one drawing, it does not need to be further discussed in subsequent drawings.

It may be understood that before using the technical solutions disclosed in in the respective embodiments of the present disclosure, a user should be informed of type, usage scope, usage scenarios, etc. of personal information involved in the present disclosure and authorization from the user should be acquired according to relevant laws and regulations appropriately.

For the convenience of understanding this embodiment, firstly a search result display method disclosed in the embodiment of the present disclosure is introduced in detail; an executing body of the search result display method provided by the embodiment of the present disclosure is usually a computer device having certain computing power.

Taking the executing body as a terminal device, the search result display method provided by the embodiment of the present disclosure will be illustrated below.

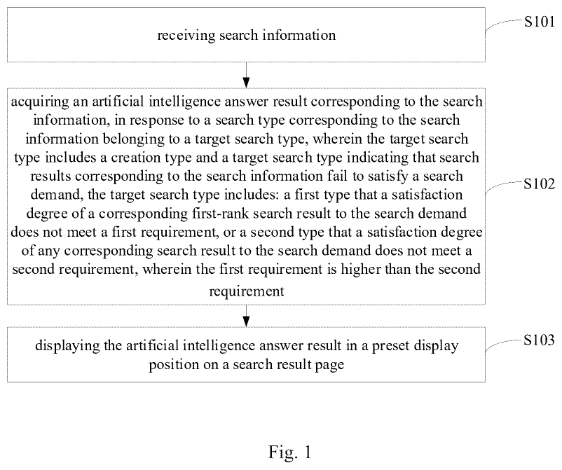

Referring to FIG. 1, FIG. 1 is a flow chart of a search result display method provided by an embodiment of the present disclosure. The method includes steps S101 to S103:
S101: receiving search information.
S102: acquiring an artificial intelligence answer result corresponding to the search information, in response to a search type corresponding to the search information belonging to a target search type, wherein the target search type includes a creation type and a target search type indicating that search results corresponding to the search information fail to satisfy a search demand, the target search type includes: a first type that a satisfaction degree of a corresponding first-rank search result to the search demand does not meet a first requirement, or a second type that a satisfaction degree of any corresponding search result to the search demand does not meet a second requirement, wherein the first requirement is higher than the second requirement.

Here, the target search type is a search type more suitable for providing relevant answer results through a trained network model than the search engine. The target search type may specifically include the creation type, the first type that a satisfaction degree of a corresponding first-rank search result to the search demand does not meet the first requirement, or the second type that a satisfaction degree of any search result to the search demand does not meet the second requirement.

The creation type is, for example, textual work creation, etc. An AI-based network model may provide real-time and random creation results for the search of the creation type. With respect to the search information of the above-described first type, although the search result ranked first (usually a search result with the highest degree of matching the search information) among the corresponding respective search results gives an answer relatively matching the search information to a certain extent, yet the satisfaction degree to the search demand is not high, or say, the search demand is not well satisfied (e.g., the search demand is a multi-answer integrated type, but the search result ranked first is a single answer). Since the search results ranked thereafter usually have an even lower degree of matching the search information, it may be considered that in such cases, the search results provided by the search engine do not satisfy the search demand. With respect to the search information of the above-described second type, the corresponding respective search results all have a relatively low satisfaction degree to the search demand, that is, it may be considered that no search result satisfies the search demand.

In a specific implementation, it may be determined whether the search information belongs to the creation type based on the semantic information of the search information. Specifically, whether the search information belongs to the creation type may be recognized through keyword comparison or a trained network model. For example, the received search information is a composition for third-grade elementary school students, which is recognized through the keyword “composition” or a trained network model, and it may be determined that the search type corresponding to the search information is the creation type.

Further, in a case where the search information belongs to a non-creation type, the search type of the search information may be subdivided according to whether the satisfaction degree of the search results corresponding to the search information to the search demand meets the requirement. For example, if the satisfaction degree of the first-rank search result to the search demand does not meet the first requirement, that is, even the first-rank search result that is most likely to satisfy the search demand among the plurality of search results cannot satisfy the search demand well, it may be determined that the search type corresponding to the search information is the first type; if a satisfaction degree of any corresponding search result to the search demand does not meet the second requirement, that is, no search result generally satisfies the search demand among the plurality of search results, it may be determined that the search type corresponding to the search information is the second type. The satisfaction degree here may be computed from aspects such as user feedback, interaction data with search results (trigger clicks, browsing duration, etc.), and so on.

Here, the first-rank search result corresponds to the search result that is most likely to satisfy the search demand, a requirement condition corresponding to the satisfaction degree of the first-rank search result to the search demand may be set higher than a requirement condition corresponding to a satisfaction degree of any search result to the search demand, that is, the first requirement may be set higher than the second requirement.

After determining that the search type corresponding to the search information belongs to the target search type, the artificial intelligence answer result corresponding to the search information may be generated by using the artificial intelligence technology.

In a case where the search type corresponding to the search information varies, a display mode of the artificial intelligence answer result on a search result page varies, which will be specifically illustrated in detail in S103.
S103: displaying the artificial intelligence answer result in a preset display position on a search result page.

In a case where the search type corresponding to the search information varies, the preset display position for displaying the answer results varies.

In a case where the search type corresponding to the search information belongs to the creation type, the number of acquired artificial intelligence answer results may be at least one.

In one implementation, when the artificial intelligence answer result includes a plurality of answer results, one of the plurality of answer results may be displayed on the preset display position; and a next answer result among the plurality of answer results may be displayed in response to an answer result switch operation.

The preset display position may be any display position on the search result page; and in one embodiment, the preset display position may be the first display position on the search result page.

The one answer result displayed may be randomly selected from the plurality of answer results or may also be displayed in a preset ranking order of the plurality of answer results.

The answer result switch operation may be implemented by a user triggering an answer result switch control (e.g., a switch button) displayed on the search result page, or by a user issuing a voice command. Here, an implementation of the answer result switch operation is not specifically limited.

In a case where the one answer result displayed is randomly selected from the plurality of answer results, the next answer result may also be randomly selected from the remaining answer results; and in a case where the one answer result is displayed according to the preset ranking order of the plurality of answer results, the next answer result may also be determined according to the preset ranking order.

Further, in a case where the artificial intelligence answer result includes a plurality of answer results, a mode of switching answer results may include switching answer results in one artificial intelligence card, or may also include switching artificial intelligence cards. Next, a process of displaying the next answer result among the plurality of answer results will be introduced respectively with respect to the two switching modes.

With respect to the first mode of switching answer results: the artificial intelligence card may be displayed in the preset display position, and one of the plurality of answer results may be displayed in the artificial intelligence card; and the answer result in the artificial intelligence card is switched to the next answer result among the plurality of answer results in response to the answer result switch operation.

That is, one artificial intelligence card may be set up here, and the artificial intelligence card is displayed in the preset display position. When executing the answer result switch operation, the artificial intelligence card may display the next answer result. In a specific implementation, after displaying all answer results, prompt information indicating that all answer results have been displayed may be displayed, or the above-described answer results may also be re-displayed.

With respect to a second mode of switching answer results: the first artificial intelligence card may be displayed in the preset display position, and one of the plurality of answer results may be displayed in the first artificial intelligence card; the first artificial intelligence card is switched to the next artificial intelligence card in response to the answer result switch operation, and the next artificial intelligence card may display the next answer result among the plurality of answer results.

That is to say, a plurality of artificial intelligence cards may be set up here, and only one artificial intelligence card may be displayed in the preset display position; each artificial intelligence card may display one answer result among the plurality of answer results. When executing the answer result switch operation, the currently displayed artificial intelligence card is switched to the next artificial intelligence card. In a specific implementation, after displaying all artificial intelligence cards, prompt information indicating that all artificial intelligence cards have been displayed may be displayed, or the above-described artificial intelligence cards may also be re-displayed.

The first artificial intelligence card displayed may be randomly selected from the plurality of artificial intelligence cards or may also be displayed in a preset ranking order of the plurality of artificial intelligence cards.

In a case where the first artificial intelligence card displayed is randomly selected from the plurality of answer results, the next artificial intelligence card may also be randomly selected from the remaining artificial intelligence cards; and in a case where the first artificial intelligence card is displayed in the preset ranking order of the plurality of artificial intelligence cards, the next artificial intelligence card may be determined according to the preset ranking order.

In one embodiment, in the process of switching artificial intelligence cards, a card-switching animatic effect may also be displayed. For example, a previous artificial intelligence card moves out of a screen from the left, and the next artificial intelligence card enters the screen from the right, so as to present a card-switching effect. In a specific implementation, the mode of the card-switching animatic effect is not specifically limited.

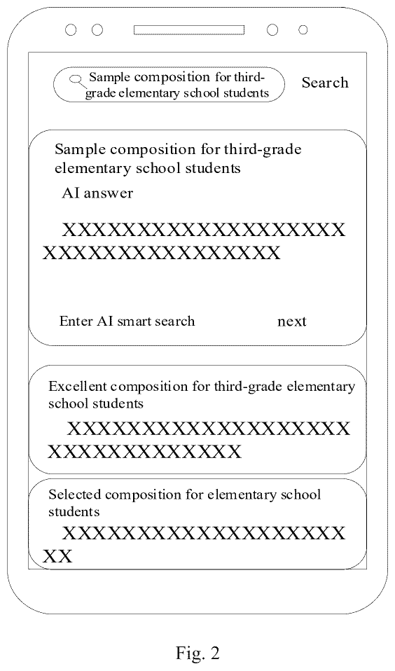

FIG. 2 shows a schematic diagram of a search result page. A search box on the search result page displays the received search information “Sample composition for third-grade elementary school students”. A first display position on the search result page displays an artificial intelligence card; the artificial intelligence card displays “Sample composition for third-grade elementary school students” and at least a portion of generated composition content. A lower right corner of the artificial intelligence card displays a “Next” button; the “Next” button may be clicked to switch to display the next “artificial intelligence card”, and the next artificial intelligence card displays the next answer result. A lower-left corner of the artificial intelligence card displays a button “Enter AI smart search” for entering an artificial intelligence search page, and the button “Enter AI smart search” may be clicked to enter the artificial intelligence search page and display the entire content of the composition.

In a case where the search type corresponding to the search information belongs to the first type, in one implementation, the answer result may be displayed above the respective search results on the search result page.

Here, in a case where the first-rank search result does not satisfy the demand, the AI answer results may be displayed in a position corresponding to the first-rank search result, allowing the user to quickly browse to the result that satisfies the demand.

In a case where the search type corresponding to the search information belongs to the second type, in one implementation, a structured AI answer result may be displayed in a preset display position on the search result page.

Here, the structured AI answer result includes a plurality of structured answers and comparison information between the plurality of structured answers; and the structured answer includes information under a plurality of content dimensions.

Different structured answers may correspond to different content dimensions; the content dimensions may match the search information. For example, the search information may be: What are the coastal cities suitable for playing in? The acquired answer results may include structured answers under a plurality of content dimensions such as characteristics of scenic spots, travel modes, and travel costs in respective coastal cities, as well as comparison information under the plurality of content dimensions. For example, the search information may include: the bloom time of respective flowers. The acquired answer results may include structured answers under a plurality of content dimensions, such as names, bloom months, and bloom durations of respective flowers, as well as comparison information under the plurality of content dimensions.

By displaying the structured AI answer result, the user may obtain a satisfactory answer in the same answer result, without combining a plurality of search results to obtain a result that satisfies the search demand.

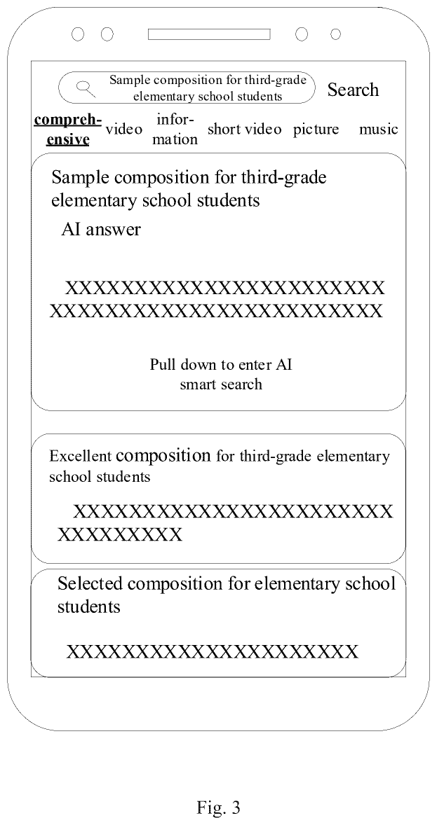

The search result page may display respective vertical tags; and in one embodiment, the AI answer result may be displayed in a first display position under a target vertical tag (e.g., comprehensive). After the first display position, search results corresponding to the search information or other search results may be displayed. FIG. 3 shows a schematic diagram of another search result page. A search box is displayed in the top position of the search result page; the search box displays the received search information “Sample composition for third-grade elementary school students”; and respective vertical tags, that is, comprehensive, video, information, short video, picture, music, etc., are displayed below the search box; and a composition content generated based on the “Sample composition for third-grade elementary school students” is displayed in the first display position under the comprehensive vertical tag; identification information of “AI answer” is displayed in an upper left corner of the composition content; and the identification information may prompt the user that the composition content below is an artificial intelligence answer result. The displayed composition content may be a portion of the content. Prompt information “Pull down to enter AI smart search” may be further displayed below the composition content. After the user pulls down the screen, it may enter the artificial intelligence search page to display the entire content of the composition content. Search results corresponding to the search information are displayed after the composition content. The comprehensive vertical tag may be displayed in bold.

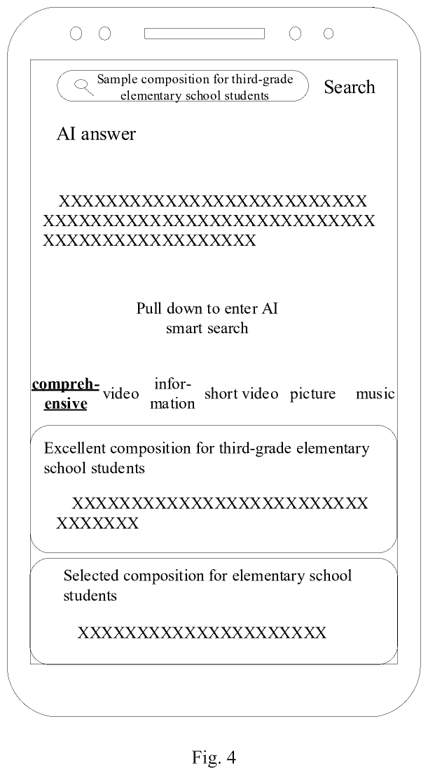

In one embodiment, the answer result may be displayed above the respective vertical tags, and the respective vertical tags and the search results under the target vertical tag may be displayed below the AI answer result. As shown in FIG. 4, which is a schematic diagram of another search result page, a search box is displayed in the top position of the search result page; the search box displays the received search information “Sample composition for third-grade elementary school students”; the composition content generated based on the search information is displayed below the search box; identification information “AI answer” is displayed in an upper left corner of the composition content; and the identification information may prompt the user that the composition content below is an artificial intelligence answer result. Prompt information “Pull down to enter AI smart search” may be further displayed below the composition content. After the user pulls down the screen, it may enter the artificial intelligence search page to display the entire content of the composition content. Respective vertical tags, that is, comprehensive, video, information, short video, picture, music, etc., are displayed after the composition content; and respective Search results corresponding to the search information may be displayed below the comprehensive vertical tag. The comprehensive vertical tag may be displayed in bold.

In one implementation, the answer result may be displayed in a target consumption window in the preset display position; and at least a portion of the content of the answer result may be displayed in the target consumption window, that is, a portion of the content of the answer result may be displayed, or the entire content of the answer result may also be displayed.

In a case where a portion of the content of the answer result is displayed within the target consumption window, the answer result may be updated and displayed within the target consumption window in response to a slide operation for the target consumption window.

Here, the slide operation for the target consumption window may be a slide operation in a preset direction, and the slide operation may be implemented by a user triggering a slide control (e.g., a scroll bar) within the target consumption window, or may also be implemented by sliding a screen region of the target consumption window. The implementation of the slide operation is not specifically limited here. By sliding the target consumption window, the remaining content that has not been displayed may be displayed, so that the user may browse all answer results.

In one implementation, entering the artificial intelligence search page after displaying the AI answer result. Here, the artificial intelligence search page may be displayed in response to a trigger operation for the AI answer result; the artificial intelligence search page displays the entire content of the AI answer result, and instruction information for inputting question information, to update the AI answer result according to the question information.

In specific implementation, the trigger operation for the answer result may be implemented by triggering the answer result; or may also be implemented by triggering prompt information of entering the artificial intelligence search page in the preset display position on the search result page. As shown in FIG. 3 or FIG. 4, the prompt information “Pull down to enter AI smart search” is displayed on the search result page, after the user pulls down the screen, it may enter the artificial intelligence search page. The implementation for entering the artificial intelligence search page is not specifically limited here.

In addition to displaying the entire content of the AI answer result, the artificial intelligence search page may further display instruction information instructing to input question information. In one embodiment, the instruction information may be displayed in a question input box. After the user inputs the question information, the artificial intelligence search page may display the updated answer result according to the question information.

Here, the question information may be customized by the user, or may also be selected from candidate question information displayed on the artificial intelligence search page. The candidate question information displayed on the artificial intelligence search page may be question information related to the search information. The input question information may be the question information related to the search information or may also be unrelated question information.

The artificial intelligence search page may further display prompt information instructing to switch answer results. The entire content of the next answer result may be displayed on the artificial intelligence search page in response to a trigger operation for the prompt information.

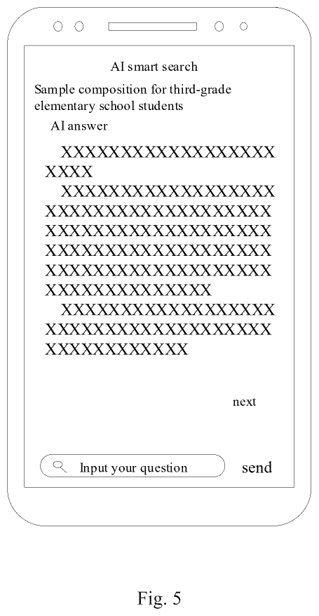

FIG. 5 shows a schematic diagram of an artificial intelligence search page. The artificial intelligence search page displays the “Sample composition for third-grade elementary school students” and all the generated composition content. A “Next” button is displayed in the lower right corner of the composition content, and the “Next” button may be clicked to switch to display the next composition content. A question input box is displayed at the bottom of the artificial intelligence search page; the question input box displays instruction information “Input your question” instructing to input question information, and after the user inputs the question information and clicks a “Send” button, the updated answer result based on the question information may be displayed on the artificial intelligence search page.

In the process of generating the artificial intelligence answer result, in order to prompt the user, in one implementation, before acquiring the artificial intelligence answer result corresponding to the search information, the search result page may display respective search results corresponding to the search information and prompt information prompting that the artificial intelligence answer result is being generated. Displaying the AI answer result in the preset display position on the search result page may include: canceling a display of the prompt information and displaying the answer result in the preset display position.

In the process of generating the artificial intelligence answer result, respective search results corresponding to the search information may be displayed first, and meanwhile, the prompt information prompting that the artificial intelligence answer result is being generated may be displayed. Canceling the display of the prompt information and displaying the answer result in the preset display position after generating the artificial intelligence answer result.

the user may be prompted that the artificial intelligence answer result is currently being generated by displaying the prompt information prompting that the artificial intelligence answer result is being generated, so that the user may timely understand a current display state.

In one embodiment, the search result page may further display an artificial intelligence search page entrance. By triggering the artificial intelligence search page entrance, it may directly enter the artificial intelligence search page and display the entire content of the answer result corresponding to the search information on the artificial intelligence search page.

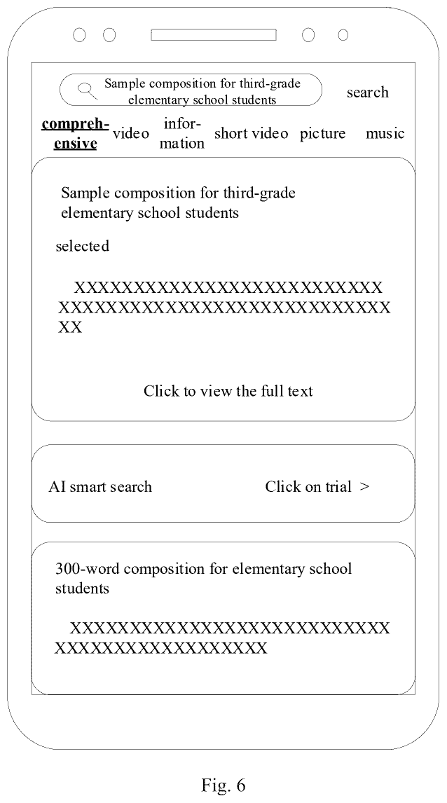

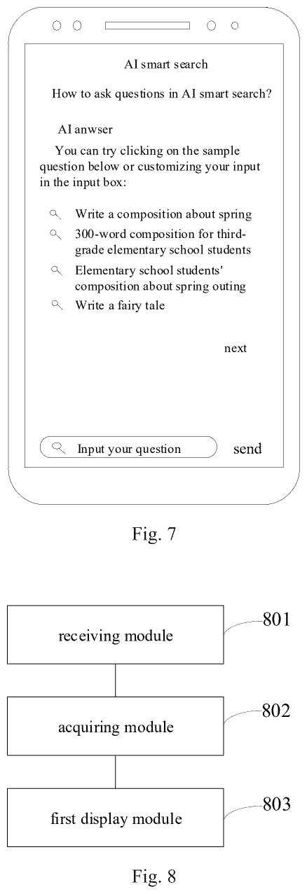

After receiving the search information, as shown in FIG. 6, which is a schematic diagram of another type of search result page, the search result page may display respective search results corresponding to the search information “Sample composition for third-grade elementary school students”, and the search result page displays the artificial intelligence search page entrance in the preset display position. After the user triggers the artificial intelligence search page entrance, the artificial intelligence search page may be displayed, as shown in FIG. 7, which is a schematic diagram of another type of artificial intelligence search page, the artificial intelligence search page displays prompt information prompting the user to input question information to generate the artificial intelligence answer result and displays a plurality of pieces of candidate question information. A question input box may be displayed at the bottom of the artificial intelligence search page. A search identifier is displayed before each piece of candidate prompt information, and after triggering any piece of candidate prompt information, the answer result may be directly generated. The question input box displays instruction information “Input your question” instructing to input question information; the user may select target prompt information from the plurality of pieces of candidate question information so that the artificial intelligence search page displays the updated answer result based on the target question information. Alternatively, the user may input question information in the question input box and click the “Send” button, so that the artificial intelligence search page displays the updated answer result based on the question information.

Those skilled in the art may understand that in the above-described method according to the specific implementations, a writing order of the respective steps does not imply a strict execution order or impose any limitations on the implementation process; and the specific execution order of the respective steps should be determined by a function and possible internal logic thereof.

Based on the same invention concept, an embodiment of the present disclosure further provides a search result display apparatus corresponding to the search result display method. Because the principle on which the apparatus solves the problem according to the embodiment of the present disclosure is similar to that of the above-described search result display method according to the embodiment of the present disclosure, the implementation of the method may be referred to for implementation of the apparatus, and no details will be repeated here.

Referring to FIG. 8, FIG. 8 is a structural schematic diagram of a search result display apparatus provided by an embodiment of the present disclosure. The apparatus includes:
a receiving module 801, configured to receive search information;
an acquiring module 802, configured to acquire an artificial intelligence answer result corresponding to the search information in response to a search type corresponding to the search information belonging to a target search type, wherein the target search type includes a creation type and a target search type indicating that search results corresponding to the search information fail to satisfy a search demand, the target search type includes: a first type that a satisfaction degree of a corresponding first-rank search result to the search demand does not meet a first requirement, or a second type that a satisfaction degree of any corresponding search result to the search demand does not meet a second requirement, wherein the first requirement is higher than the second requirement; and
a first display module 803, configured to display the artificial intelligence answer result in a preset display position on a search result page.

In an alternative embodiment, the search type corresponding to the search information belongs to the creation type, and the artificial intelligence answer result corresponding to the search information includes a plurality of answer results;
the first display module 803 is specifically configured for:
displaying one of the plurality of answer results in the preset display position, and displaying a next answer result among the plurality of answer results in response to an answer result switch operation.

In an alternative embodiment, the first display module 803 is specifically configured for:
displaying an artificial intelligence card in the preset display position, wherein one of the plurality of answer results is displayed in the artificial intelligence card; and switching the answer result in the artificial intelligence card to the next answer result among the plurality of answer results in response to the answer result switch operation; or,
displaying a first artificial intelligence card in the preset display position, wherein one of the plurality of answer results is displayed in the first artificial intelligence card; switching the first artificial intelligence card to a next artificial intelligence card in response to the answer result switch operation, wherein the next answer result among the plurality of answer results is displayed in the next artificial intelligence card.

In an alternative embodiment, the search type corresponding to the search information belongs to the first type;
the first display module 803 is specifically configured for:
displaying the artificial intelligence answer result above respective search results on the search result page.

In an alternative embodiment, the search type corresponding to the search information belongs to the second type;
the first display module 803 is specifically configured for:
displaying a structured artificial intelligence answer result in the preset display position on the search result page, wherein the structured artificial intelligence answer result includes a plurality of structured answers and comparison information between the plurality of structured answers, and each structured answer includes information under a plurality of content dimensions.

In an alternative embodiment, the first display module 803 is specifically configured for:
displaying a target consumption window in the preset display position, and displaying at least part of content of the artificial intelligence answer result within the target consumption window;
updating and displaying the artificial intelligence answer result within the target consumption window in response to a slide operation for the target consumption window.

In an alternative embodiment, the apparatus further includes:
a second display module, configured for displaying respective search results corresponding to the search information and prompt information on the search result page, wherein the prompt information is used to prompt that the artificial intelligence answer result is being generated;
the first display module 803 is specifically configured for:
canceling a display of the prompt information and displaying the artificial intelligence answer result in the preset display position.

In an alternative embodiment, the apparatus further includes:
a third display module, configured for, in response to a trigger operation for the artificial intelligence answer result, displaying an artificial intelligence search page, displaying the entire content of the artificial intelligence answer result and instruction information for instructing to input question information on the artificial intelligence search page, to update the artificial intelligence answer result according to the question information.

The relevant description in the above-described method embodiment may be referred to as a description of a processing flow of respective modules and an interaction flow between the respective modules in the apparatus, and no details will be repeated here.

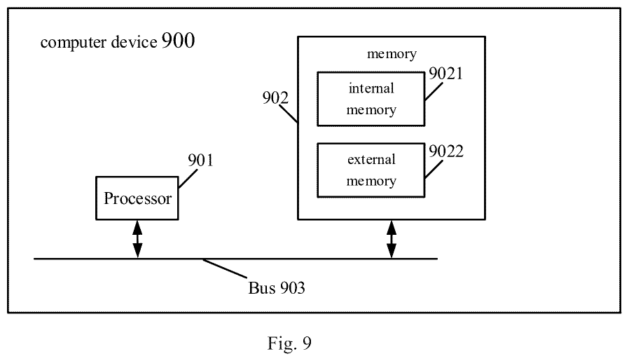

Based on the same invention concept, an embodiment of the present disclosure further provides a computer device. Referring to FIG. 9, which is a structural schematic diagram of a computer device 900 provided by an embodiment of the present disclosure, including: a processor 901, a memory 902, and a bus 903. The Memory 902 is configured to store execution instructions, and includes an internal memory 9021 and an external memory 9022; here the internal memory 9021 is also referred to as built-in memory, and is configured to temporarily store operation data in the processor 901 and data exchanged with the external memory 9022 such as a hard disk; the processor 901 exchanges data with the external memory 9022 through the internal memory 9021; when the computer device 900 is running, the processor 901 communicates with the memory 902 through the bus 903, causing the processor 901 to execute instructions below:
receiving search information;
acquiring an artificial intelligence answer result corresponding to the search information, in response to a search type corresponding to the search information belonging to a target search type, wherein the target search type includes a creation type and a target search type indicating that search results corresponding to the search information fail to satisfy a search demand, the target search type includes: a first type that a satisfaction degree of a corresponding first-rank search result to the search demand does not meet a first requirement, or a second type that a satisfaction degree of any corresponding search result to the search demand does not meet a second requirement, wherein the first requirement is higher than the second requirement; and
displaying the artificial intelligence answer result in a preset display position on a search result page.

An embodiment of the present disclosure further provides a computer-readable storage medium, having a computer program stored thereon; wherein, the computer program, when run by a processor, executes the steps of the search result display method according to the above-described method embodiment. The storage medium may be a volatile or non-volatile computer-readable storage medium.

An embodiment of the present disclosure further provides a computer program product, carrying a program code; wherein, the program code includes instructions used for executing the steps of the search result display method according to the above-described method embodiment, the above-described method embodiment may be referred to for details, and no details will be repeated here.

The above-described computer program product may be specifically implemented through hardware, software, or a combination thereof. In one optional embodiment, the computer program product is specifically embodied as a computer storage medium; while in another optional embodiment, the computer program product is specifically embodied as a software product, for example, a software development kit (SDK), and so on.

Those skilled in the art may clearly understand that for the convenience and conciseness of description, the corresponding process in the above-described method embodiments may be referred to for the specific operation process of the system and the apparatus as described above, and no details will be repeated here. In several embodiments provided by the present disclosure, it should be understood that the disclosed system, apparatus, and method may be implemented in other ways. The apparatus embodiment as described above is merely exemplary. For example, the unit division is merely a logical function division and there may be other division modes in actual implementation; for example, a plurality of units or components may be combined or integrated into another system, or some features may be ignored or not executed. One more point is that mutual coupling or direct coupling, or communicative connection between the respective components as displayed or discussed may be an indirect coupling or communicative connection through some communication interfaces, apparatuses, or units, and it may be electrical, mechanical, or in other form.

The above-described units illustrated as separate parts may be, or may not be physically separated, and the units displayed as parts may be, or may not be, physical units, that is, they may be located in one place, or may also be distributed to a plurality of network units; and some or all of the units may be selected according to actual needs to achieve the purpose of the solutions of this embodiment.

In addition, the respective functional units according to the respective embodiments of the present disclosure may be integrated into a processing unit, or the respective units may also exist physically alone, or two or more units may also be integrated into one unit.

If the function is implemented in the form of a software functional module and sold or used as an independent product, it may also be stored in a non-volatile computer-readable storage medium executable by a processor. Based on such understanding, the technical solution of the present disclosure, in essence, or the part that contributes to the prior art, or the part of the technical solution, may be embodied in the form of a software product; the computer software product is stored in a storage medium and includes several instructions to cause a computer device (which may be a personal computer, a server, or a network device, etc.) to execute all or part of the steps of the methods according to the respective embodiments of the present disclosure. The foregoing storage medium includes a USB flash drive, a portable hard drive, a read-only memory (ROM), a random-access memory (RAM), a magnetic disk or an optical disc, and various other media that may store program codes.

Finally, it should be noted that the above are only specific embodiments of the present disclosure and are used for explaining the technical solution of the present disclosure, and not intended to define the technical solution of the present disclosure; but the scope of the embodiment of the present disclosure is not limited thereto. Although the present disclosure is explained in detail regarding the foregoing embodiments, those ordinarily skilled in the art will readily appreciate that: any skilled in the art, within the technical scope disclosed by the present disclosure, may still make modifications to the technical solutions recorded in the foregoing embodiments, or easily think of variations, or make equivalent substitutions for part of technical features; however, these modifications, variations or substitutions are not intended to make the essences of the corresponding technical solutions depart from the spirit and the scope of the technical solutions of the embodiments of the present disclosure, which should be covered within the protection scope of the present disclosure. Therefore, the scope of the present disclosure should be the scope of the following claims.

1. A search result display method, comprising:
receiving search information;
acquiring an artificial intelligence answer result corresponding to the search information, in response to a search type corresponding to the search information belonging to a target search type, wherein the target search type comprises a creation type and a first search type indicating that search results corresponding to the search information fail to satisfy a search demand, the first search type comprises: a first type that a satisfaction degree of a first-rank search result in the search results to the search demand does not meet a first requirement, or a second type that a satisfaction degree of any search result in the search results to the search demand does not meet a second requirement, wherein the first requirement is higher than the second requirement; and
displaying the artificial intelligence answer result in a preset display position on a search result page.

2. The search result display method according to claim 1, wherein the search type corresponding to the search information belongs to the creation type, and the artificial intelligence answer result corresponding to the search information comprises a plurality of answer results;
the displaying the artificial intelligence answer result in a preset display position on a search result page, comprises:
displaying one of the plurality of answer results in the preset display position, and displaying a next answer result among the plurality of answer results in response to an answer result switch operation.

3. The search result display method according to claim 2, wherein the displaying one of the plurality of answer results in the preset display position, and displaying a next answer result among the plurality of answer results in response to an answer result switch operation, comprises:
displaying an artificial intelligence card in the preset display position, wherein one of the plurality of answer results is displayed in the artificial intelligence card; and switching the answer result in the artificial intelligence card to the next answer result among the plurality of answer results in response to the answer result switch operation; or, displaying a first artificial intelligence card in the preset display position, wherein one of the plurality of answer results is displayed in the first artificial intelligence card; switching the first artificial intelligence card to a next artificial intelligence card in response to the answer result switch operation, wherein the next answer result among the plurality of answer results is displayed in the next artificial intelligence card.

4. The search result display method according to claim 1, wherein the search type corresponding to the search information belongs to the first type;
the displaying the artificial intelligence answer result in a preset display position on a search result page, comprises:
displaying the artificial intelligence answer result above respective search results on the search result page.

5. The search result display method according to claim 1, wherein the search type corresponding to the search information belongs to the second type;
the displaying the artificial intelligence answer result in a preset display position on a search result page, comprises:
displaying a structured artificial intelligence answer result in the preset display position on the search result page, wherein the structured artificial intelligence answer result comprises a plurality of structured answers and comparison information between the plurality of structured answers, and each structured answer comprises information under a plurality of content dimensions.

6. The search result display method according to claim 1, wherein the displaying the artificial intelligence answer result in a preset display position on a search result page, comprises:
displaying a target consumption window in the preset display position, and displaying at least part of content of the artificial intelligence answer result within the target consumption window;
updating and displaying the artificial intelligence answer result within the target consumption window in response to a slide operation for the target consumption window.

7. The search result display method according to claim 1, wherein, before the acquiring an artificial intelligence answer result corresponding to the search information, the method further comprises:
displaying the search results corresponding to the search information and prompt information on the search result page, wherein the prompt information is used to prompt that the artificial intelligence answer result is being generated;
the displaying the artificial intelligence answer result in a preset display position on a search result page, comprises:
canceling a display of the prompt information and displaying the artificial intelligence answer result in the preset display position.

8. The search result display method according to claim 1, wherein, after the displaying the artificial intelligence answer result in a preset display position on a search result page, the method further comprises:
in response to a trigger operation for the artificial intelligence answer result, displaying an artificial intelligence search page, displaying entire content of the artificial intelligence answer result and instruction information for instructing to input question information on the artificial intelligence search page, to update the artificial intelligence answer result according to the question information.

9. A search result display apparatus, comprising:
a receiving module, configured to receive search information;
an acquiring module, configured to acquire an artificial intelligence answer result corresponding to the search information in response to a search type corresponding to the search information belonging to a target search type, wherein the target search type comprises a creation type and first search type indicating that search results corresponding to the search information fail to satisfy a search demand, the first search type comprises: a first type that a satisfaction degree of a first-rank search result in the search results to the search demand does not meet a first requirement, or a second type that a satisfaction degree of any search result in the search results to the search demand does not meet a second requirement, wherein the first requirement is higher than the second requirement; and
a first display module, configured to display the artificial intelligence answer result in a preset display position on a search result page.

10. A computer device, comprising:
a processor, a memory, and a bus,
wherein the memory stores machine-readable instructions executable by the processor, when the computer device is running, the processor communicates with the memory through the bus; and
the machine-readable instructions, when executed by the processor, execute a search result display method,
wherein the search result display method comprises:
receiving search information;
acquiring an artificial intelligence answer result corresponding to the search information, in response to a search type corresponding to the search information belonging to a target search type, wherein the target search type comprises a creation type and a first search type indicating that search results corresponding to the search information fail to satisfy a search demand, the first search type comprises: a first type that a satisfaction degree of a first-rank search result in the search results to the search demand does not meet a first requirement, or a second type that a satisfaction degree of any search result in the search results to the search demand does not meet a second requirement, wherein the first requirement is higher than the second requirement; and
displaying the artificial intelligence answer result in a preset display position on a search result page.

11. A non-transitory computer-readable storage medium, having a computer program stored thereon, wherein the computer program, when run by a processor, executes the search result display method according to claim 1.

12. The computer device according to claim 10, wherein the search type corresponding to the search information belongs to the creation type, and the artificial intelligence answer result corresponding to the search information comprises a plurality of answer results;
the displaying the artificial intelligence answer result in a preset display position on a search result page, comprises:
displaying one of the plurality of answer results in the preset display position, and displaying a next answer result among the plurality of answer results in response to an answer result switch operation.

13. The computer device according to claim 12, wherein the displaying one of the plurality of answer results in the preset display position, and displaying a next answer result among the plurality of answer results in response to an answer result switch operation, comprises:
displaying an artificial intelligence card in the preset display position, wherein one of the plurality of answer results is displayed in the artificial intelligence card; and switching the answer result in the artificial intelligence card to the next answer result among the plurality of answer results in response to the answer result switch operation; or,
displaying a first artificial intelligence card in the preset display position, wherein one of the plurality of answer results is displayed in the first artificial intelligence card; switching the first artificial intelligence card to a next artificial intelligence card in response to the answer result switch operation, wherein the next answer result among the plurality of answer results is displayed in the next artificial intelligence card.

14. The computer device according to claim 10, wherein the search type corresponding to the search information belongs to the first type;
the displaying the artificial intelligence answer result in a preset display position on a search result page, comprises:
displaying the artificial intelligence answer result above respective search results on the search result page.

15. The computer device according to claim 10, wherein the search type corresponding to the search information belongs to the second type;
the displaying the artificial intelligence answer result in a preset display position on a search result page, comprises:
displaying a structured artificial intelligence answer result in the preset display position on the search result page, wherein the structured artificial intelligence answer result comprises a plurality of structured answers and comparison information between the plurality of structured answers, and each structured answer comprises information under a plurality of content dimensions.

16. The computer device according to claim 10, wherein the displaying the artificial intelligence answer result in a preset display position on a search result page, comprises:
displaying a target consumption window in the preset display position, and displaying at least part of content of the artificial intelligence answer result within the target consumption window;
updating and displaying the artificial intelligence answer result within the target consumption window in response to a slide operation for the target consumption window.

17. The computer device according to claim 10, wherein, before the acquiring an artificial intelligence answer result corresponding to the search information, the computer device is further configured for:
displaying the search results corresponding to the search information and prompt information on the search result page, wherein the prompt information is used to prompt that the artificial intelligence answer result is being generated;
the displaying the artificial intelligence answer result in a preset display position on a search result page, comprises:
canceling a display of the prompt information and displaying the artificial intelligence answer result in the preset display position.

18. The computer device according to claim 10, wherein, after the displaying the artificial intelligence answer result in a preset display position on a search result page, the computer device is further configured for:
in response to a trigger operation for the artificial intelligence answer result, displaying an artificial intelligence search page, displaying entire content of the artificial intelligence answer result and instruction information for instructing to input question information on the artificial intelligence search page, to update the artificial intelligence answer result according to the question information.
